(19) United States
(12) Patent Application Publication
(10) Pub. No.: US 2010/0301136 A1
(43) Pub. Date: Dec. 2, 2010

(54) Combined spray container and wipe dispensing device

(76) Inventor: Dexter L. Scott, GREENFIELD, CA (US)

Correspondence Address: RICHARD L. MILLER, 12 PARKSIDE DRIVE, DIX HILLS, NY, 11746, US

(21) Appl. No.: 12/454,920

(22) Filed: May 26, 2009

(51) Int. Cl. B05B 15/00

(52) U.S. Cl. 239/289

(57) ABSTRACT

A combined spray container and wipe dispensing device which comprises a spray bottle, a disposable wiping structure, and a mechanism for operatively connecting the disposable wiping structure to one side of the spray bottle, wherein a person can utilize both the spray bottle and the disposable wiping structure in conjunction with each other.

### BACKGROUND OF THE INVENTION

1. Field of the Invention

The present invention relates to a cleaning apparatus, and more particularly, a combined spray container and wipe dispensing device.

2. Description of the Prior Art

Numerous innovations for various combination spray bottles and paper towel holders have been provided in the prior art that will be described. Even though these innovations may be suitable for the specific individual purposes to which they address, however, they differ from the present invention.

A FIRST EXAMPLE, U.S. Patent Office Document No. D363214, Issued on Oct. 17, 1995, to Parola et al. teaches an ornamental design for a combined spray bottle and paper towel holder, as shown.

A SECOND EXAMPLE, U.S. Pat. No. 6,138,874, Issued on Oct. 31, 2000, to Audrey teaches a dispenser for fluids and paper towels that is a combination fluid container and wiper dispenser having a base portion from the top center portion of which extends upwardly a neck tube having at its top an opening. The neck tube is sized such that a paper towel roll may be placed on the neck tube and rest on the base portion. The base portion and neck tube are hollow forming the fluid chamber and a mechanical pump device with siphon tube is attached to the top of the tube for dispensing fluid. The neck tube is extended to provide for ease in holding the dispenser in one hand while performing a cleaning operation.

A THIRD EXAMPLE, U.S. Pat. No. 6,216,920, Issued on Apr. 17, 2001, to Baggett teaches a combination spray bottle and paper towel holder configured and arranged to prevent an edge of a roll of paper towels from being damaged by condensate and/or fraying, comprising a body having a shaft, a base, a hand grip, a flange, a threaded screw-top; a tensioner; and a spray assembly. The body serves as a reservoir for liquids. The roll of paper towels is inserted over the shaft, rests on the flange and does not contact the base. The tensioner maintains pressure on the roll of paper towels, preventing the uncontrolled unrolling thereof. The tensioner is attached to the spray bottle at two attachment locations, located on the body at locations beyond either edge of the roll of paper towels when the roll is inserted over the shaft. At least one of the attachment locations is such that the tensioner is releasably attached thereto. A combination spray bottle and paper towel holder configured and arranged to prevent an edge of a roll of paper towels from being damaged by fraying or otherwise, comprising a body having a shaft, a base, a threaded screw-top; a tensioner; and a spray assembly; where the tensioner is attached to the spray bottle at two attachment locations, located on the body at locations beyond either edge of the roll of paper towels when the roll is inserted over the shaft, at least one of which is a non-protruding hook that prevents the edge of the roll of paper towels farthest from the base from becoming damaged. A combination spray bottle and paper towel holder configured and arranged to prevent a roll of paper towels from unrolling in an uncontrolled manner, comprising a body having a shaft, a base, a threaded screw-top; a tensioner; and a spray assembly; where the tensioner includes an elastic band, the ends of which are bound by a clasp that prevents the elastic band from losing tension or otherwise separating at the ends.

A FOURTH EXAMPLE, U.S. Patent Office Document No. 20020079380, Published on Jun. 27, 2002, to Presson teaches a combined portable, cleaning fluid spray apparatus and paper towel support and dispensing apparatus which combines the functions of a liquid window cleaner spray dispenser and a paper towel roll holder into one product. A long, tube-type arrangement fits inside a roll of paper towels, and the lower portion of the tube comprises a base which holds used and discarded paper towels in a lower compartment. A standard pump sprayer at the top connects to the tube with a threaded connection. An upper plate-type washer along with a tension rod provides a method of restraining the paper towels when not being used, as well as an easy means to tear off the paper towels during use.

A FIFTH EXAMPLE, U.S. Pat. No. 6,431,405, Issued on Aug. 13, 2002, to Irwin teaches a system combining a fluid dispenser and a pop-up sheet dispenser. The fluid dispenser is a bottle with a spray pump, while the sheet dispenser is a tub with an opening through which sheets pop out. The two dispensers snap together to trap and store sheets from a longitudinally folded web ready for pop-out dispensing. The primary embodiment may be used for spray cleaner and paper towels, for example. The sheet dispenser provides the system's base, dispensing from a roll with its core held vertically in the tub, located by the tub's core-locating hub. The fluid dispenser snaps vertically down into the sheet dispenser, acting as its lid and further locating the roll with its hub-stem. The roll, held loosely by the two hubs, may spin within the system. The tub, opening, and roll may together rotate relative to the fluid dispenser to reorient the opening. In a secondary embodiment, the sheet dispenser dispenses from a stack held vertically between the bottle and the tub which are side-by-side and snap together horizontally. Again, the bottle acts as a lid for the tub. A tertiary embodiment demonstrates how the primary embodiment may be reapplied to other products, such as cosmetic fluids and sheets.

A SIXTH EXAMPLE, U.S. Pat. No. 6,644,563, Issued on Nov. 11, 2003, to Presson teach a combined portable, cleaning fluid spray apparatus and paper towel support and dispensing apparatus which combines the functions of a liquid window cleaner spray dispenser and a paper towel roll holder into one product. A long, tube-type arrangement fits inside a roll of paper towels, and the lower portion of the tube comprises a base which holds used and discarded paper towels in a lower compartment. A standard pump sprayer at the top connects to the tube with a threaded connection. An upper plate-type washer along with a tension rod provides a method of restraining the paper towels when not being used, as well as an easy means to tear off the paper towels during use.

It is apparent now that numerous innovations for various combination spray bottles and paper towel holders have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a combined spray container and wipe dispensing device that avoids the disadvantages of the prior art.

ANOTHER OBJECT of the present invention is to provide a combined spray container and wipe dispensing device that is simple and inexpensive to manufacture.

STILL ANOTHER OBJECT of the present invention is to provide a combined spray container and wipe dispensing device that is simple to use.

BRIEFLY STATED, STILL YET ANOTHER OBJECT of the present invention is to provide a combined spray container and wipe dispensing device which comprises a spray bottle, a disposable wiping structure, and a mechanism for operatively connecting the disposable wiping structure to one side of the spray bottle, wherein a person can utilize both the spray bottle and the disposable wiping structure in conjunction with each other.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view of a first embodiment of the present invention;

FIG. 2 is a diagrammatic front elevational view taken in the direction of arrow 2 in FIG. 1;

FIG. 3 is a diagrammatic perspective view taken in the direction of arrow 3 in FIG. 1, showing the wipe containing and dispensing component per se;

FIG. 4 is a diagrammatic perspective view of a second embodiment of the present invention; and

FIG. 5 is a diagrammatic perspective view of the second embodiment with the roll of paper towels omitted in order to illustrate further construction details thereof.

### A MARSHALING OF REFERENCE NUMERALS UTILIZED IN THE DRAWING

10 combined spray container and wipe dispensing device
12 spray bottle of device 10
14 disposable wiping structure of device 10
16 operatively connecting mechanism of device 10
18 reservoir of spray bottle 12
20 threaded neck of reservoir 18
22 spray head of spray bottle 12
24 nozzle of spray head 22
26 trigger lever of spray head 22
28 pump of spray head 22
30 wipe containing and dispensing component of disposable wiping structure 14
32 box-shaped housing of wipe containing and dispensing component 30
34 wipe in box-shaped housing 32
36 coupling assembly for operatively connecting mechanism 16
38 forward wall of reservoir 18
40 first tube member of coupling assembly 36
42 top corner of box-shaped housing 32
44 second tube member of coupling assembly 36
46 bottom corner of box-shaped housing 32
48 first bolt member of coupling assembly 36
50 second bolt member of coupling assembly 36
52 screw cap of coupling assembly 36
54 threaded end of first bolt member 48 and second bolt member 50
56 roll of paper towels for wipe containing and dispensing component 30
58 base of operatively connecting mechanism 16
60 lower rear wall of reservoir 18
62 post of operatively connecting mechanism 16
64 screw ca of operatively connecting mechanism 16
66 threaded end of post 62

### DETAILED DESCRIPTION OF THE PREFERRED EMBODIMENT

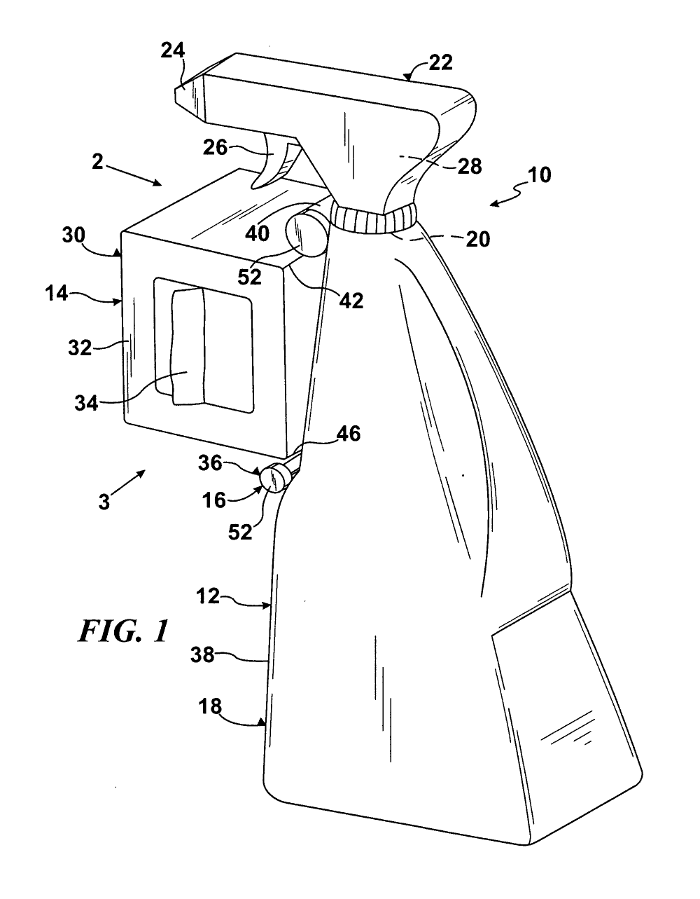

Referring now to the figures, in which like numerals indicate like parts, and particularly to FIGS. 1 through which are a diagrammatic perspective view of a first embodiment of the present invention; a diagrammatic front elevational view taken in the direction of arrow 2 in FIG. 1; a diagrammatic perspective view taken in the direction of arrow 3 in FIG. 1, showing the wipe containing and dispensing component per se; a diagrammatic perspective view of a second embodiment of the present invention; and a diagrammatic perspective view of the second embodiment with the roll of paper towels omitted in order to illustrate further construction details thereof, and as such, will be discussed with reference thereto.

The present invention is a combined spray container and wipe dispensing device 10 which comprises a spray bottle 12, a disposable wiping structure 14 and a mechanism 16 for operatively connecting the disposable wiping structure 14 to one side of the spray bottle 12, wherein a person can utilize both the spray bottle 12 and the disposable wiping structure 14 in conjunction with each other.

The spray bottle 12 comprises a reservoir 18 for holding a fluid therein. The reservoir 18 has a threaded neck 20. A spray head 22 has a nozzle 24, trigger lever 26 and pump 28 therein. The spray head 22 is threaded onto the threaded neck 20 of reservoir 18. The disposable wiping structure 14 comprises a wipe containing and dispensing component 30.

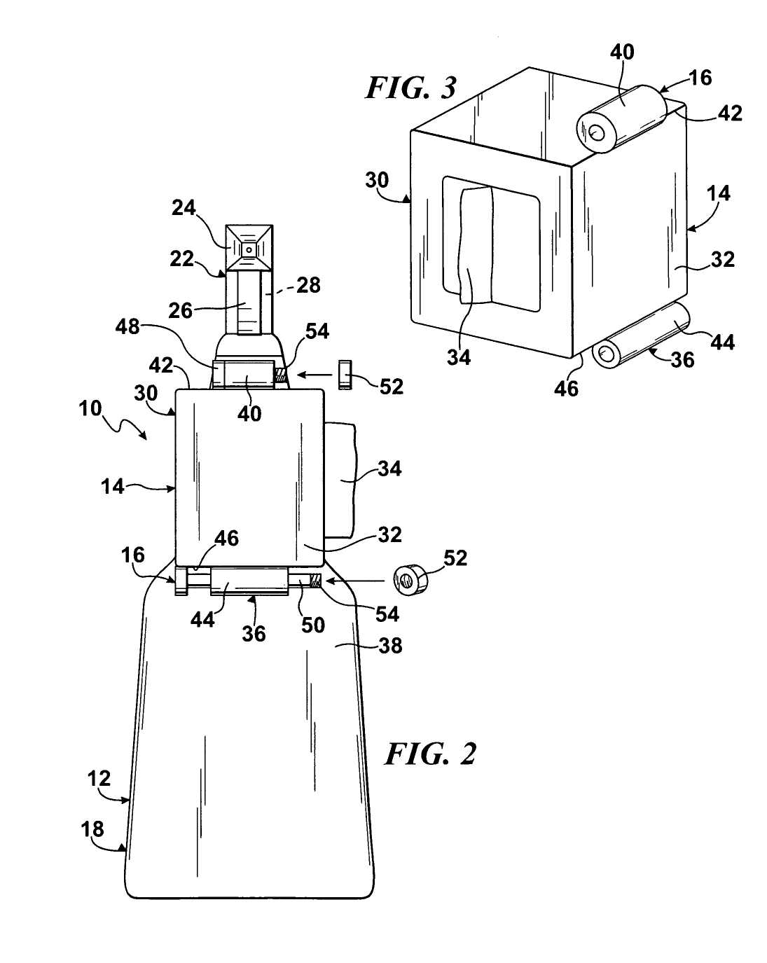

In the first embodiment the wipe containing and dispensing component 30, as shown in FIGS. 1 through 3, comprises a box-shaped housing 32 for holding a plurality of wipes 34 therein to be dispensed therefrom. The operatively connecting mechanism 16 comprises a coupling assembly 36 located between the box-shaped housing 32 of the wipe containing and dispensing component 30 and a forward wall 38 of the reservoir 18 of the spray bottle 12.

The coupling assembly 36 comprises a first tube member 40 affixed horizontally to a top corner 42 of the box-shaped housing 32 of the wipe containing and dispensing component 30. A second tube member 44 is affixed horizontally to a bottom corner 46 of the box-shaped housing 32 opposite from the first tube member 40. A first bolt member 48 is affixed horizontally to the forward wall 38 of the reservoir 18 of the spray bottle 12. A second bolt member 50 is affixed horizontally to the forward wall 38 of the reservoir 18 of the spray bottle 12 and is spaced away from the first bolt member 48. The first tube member 40 and the second tube member 44 will slip onto the first bolt member 48 and the second bolt member 50. A pair of screw caps 52 are provided. Each screw cap 52 will engage with a threaded end 54 of the first bolt member 48 and the second bolt member 50 to hold the wipe containing and dispensing component 30 thereto.

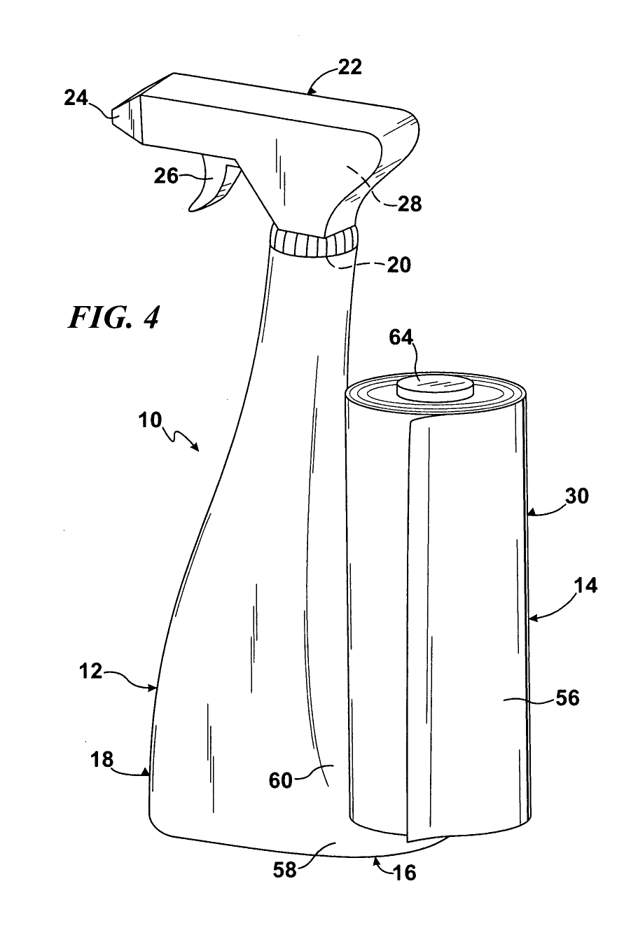

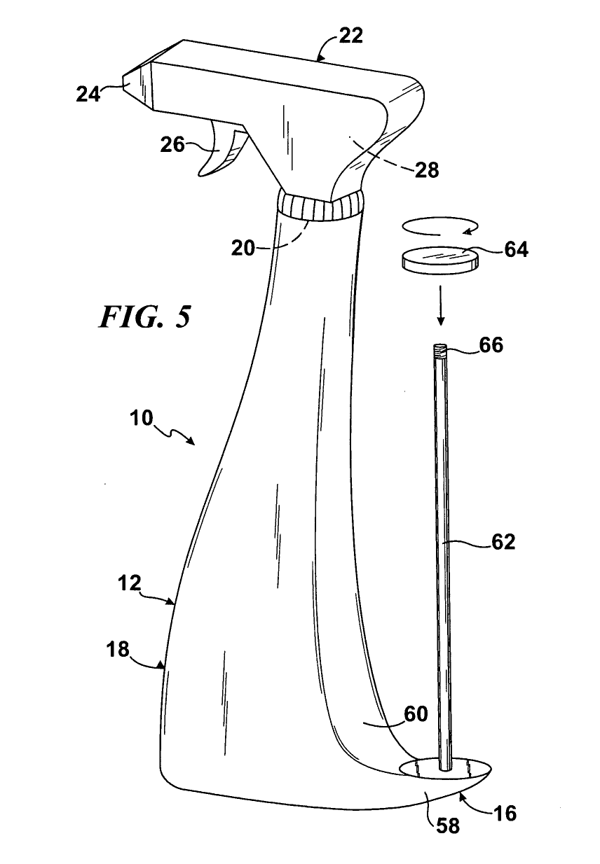

In the second embodiment the wipe containing and dispensing component 30, as shown in FIG. 4, comprises a roll of paper towels 56. The operatively connecting mechanism 16, as best seen in FIG. 5, comprises a base 58 integrally formed with a lower rear wall 60 of the reservoir 18 of the spray bottle 12. A post 62 extends vertically and upwardly from the base 58 to receive the roll of paper towels 56. A screw cap 64 engages with a threaded end 66 of the post 62 to rotatively hold the roll of paper towels 56 thereto.

It will be understood that each of the elements described above, or two or more together, may also find a useful application in other types of constructions differing from the types described above.

While the invention has been illustrated and described as embodiments of a combined spray container and wipe dispensing device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A combined spray container and wipe dispensing device which comprises:
a) a spray bottle;
b) a disposable wiping structure; and
c) means for operatively connecting said disposable wiping structure to one side of said spray bottle, wherein a person can utilize both said spray bottle and said disposable wiping structure in conjunction with each other.

2. The device as recited in claim 1, wherein said spray bottle comprises:
a) a reservoir for holding a fluid therein, said reservoir having a threaded neck; and
b) a spray head having a nozzle, trigger lever and pump therein, said spray head threaded onto said threaded neck of said reservoir.

3. The device as recited in claim 2, wherein said disposable wiping structure comprises a wipe containing and dispensing component.

4. The device as recited in claim 3, wherein said wipe containing and dispensing component comprises a box-shaped housing for holding a plurality of wipes therein to be dispensed therefrom.

5. The device as recited in claim 4, wherein said operatively connecting means comprises a coupling assembly located between said box-shaped housing of said wipe containing and dispensing component and a forward wall of said reservoir of said spray bottle.

6. The device as recited in claim 5, wherein said coupling assembly comprises:
a) a first tube member affixed horizontally to a top corner of said box-shaped housing of said wipe containing and dispensing component;
b) a second tube member affixed horizontally to a bottom corner of said box-shaped housing opposite from said first tube member;
c) a first bolt member affixed horizontally to said forward wall of said reservoir of said spray bottle;
d) a second bolt member affixed horizontally to said forward wall of said reservoir of said spray bottle and spaced away from said first bolt member, wherein said first tube member and said second tube member will slip onto said first bolt member and said second bolt member; and
e) a pair of screw caps, in which each screw cap will engage with a threaded end of said first bolt member and said second bolt member to hold said wipe containing and dispensing component thereto.

7. The device as recited in claim 3, wherein said wipe containing and dispensing component comprises a roll of paper towels.

8. The device as recited in claim 7, wherein said operatively connecting means comprises:
a) a base integrally formed with a lower rear wall of said reservoir of said spray bottle;
b) a post extending vertically and upwardly from said base to receive said roll of paper towels; and
c) a screw cap to engage with a threaded end of said post to rotatively hold said roll of paper towels thereto.
